(19) United States
(12) Patent Application Publication
(10) Pub. No.: US 2024/0053214 A1
(43) Pub. Date: Feb. 15, 2024

(54) INSPECTION TOOL AND SYSTEM FOR USE

(71) Applicants: PETRÓLEO BRASILEIRO S.A. – PETROBRAS, Rio de Janeiro (BR); SERVIÇO NACIONAL DE APRENDIZAGEM INDUSTRIAL - SENAI/SC, Florianópolis (BR)

(72) Inventors: Carlos Alberto NOGUEIRA, JR., Florianópolis (BR); Marcelo DA CRUZ RODRIGUES, Rio de Janeiro (BR); Volney Soares LOPES, Rio de Janeiro (BR); Walter Antonio KAPP, Florianópolis (BR); Eduardo César CORDEIRO VIEIRA, Florianópolis (BR)

(21) Appl. No.: 18/449,602

(22) Filed: Aug. 14, 2023

(30) Foreign Application Priority Data
Aug. 15, 2022 (BR) 1020220161461

(51) Int. Cl. G01L 19/00; E21B 47/001

(52) U.S. Cl. CPC G01L 19/0007; E21B 47/001

(57) ABSTRACT

The present invention pertains to the technical field of subsea equipment technologies dedicated to the inspection of pipes and risers and describes, according to preferred embodiments of the invention, an inspection tool and a system comprising a compliant feature of passive adaptation for inspection of the annular region of flexible pipes. The inspection tool comprises a mechanical structure with a chamber and a two-way sealing assembly comprising an inner seal and an outer seal that create a tight connection for carrying out inspection operations. Further, a system for the inspection comprising at least the inspection tool, an anchoring mechanism, an approximation mechanism and an ROV is described.

### FIELD OF THE INVENTION

The present invention pertains to the technical field of subsea equipment technologies dedicated to the inspection of pipes and risers. More specifically, the present invention relates to an inspection tool and a system comprising a compliant feature of passive adaptation for inspecting the annular region of flexible pipes.

### BACKGROUNDS OF THE INVENTION

Offshore oil production generally uses flexible pipes or flexible risers for various activities such as drilling, production, injection, completion, exportation, among others. Accordingly, flexible pipes are of high importance in offshore oil production and ensuring their integrity and reliability in their different applications must be sought.

As exemplified in FIG. 1, the flexible pipes are manufactured from several different materials and generally comprise a structure formed by several layers, each with its function. An annulus of a flexible pipe is generally defined as a volume comprised between its innermost layer (inner casing) and its outermost layer (outer casing).

The phenomenon called SCC-CO₂ (stress corrosion caused by the presence of CO₂) can cause the rupture of metallic components of flexible pipes and, thus, shorten their useful life. This phenomenon occurs when there is the presence of CO₂ and water in the annulus of the pipes.

The CO₂ comes from the permeation process of this contaminant, present in the fluid itself transported by the pipe to the annulus. Therefore, as the permeation of CO₂ to the annulus of the pipe cannot be avoided, it becomes important to know whether there is presence of water, which can enter for several reasons, in the annulus of the pipes.

Then, knowing the actual condition of the annulus allows the useful life of the pipe to be re-evaluated and possibly extended, since the presence of water must always be considered, when there is no data to affirm the opposite, penalizing the design.

One of the ways to identify the presence of water (flooding) in the annulus is through the relief valves (vent ports) installed in the connectors of the flexible pipes, as they have a direct connection with the annulus region, as also illustrated as an example in FIG. 1. To carry out the inspection of the annulus, tools attached to the relief valve are sought to gain access therethrough to the annulus of the pipe, inferring, through the pressure difference, whether there is presence of water.

One of the challenges found in the state of the art is obtaining a seal between an inspection tool and the relief valves to carry out the pressure tests, since they may be located in different regions of the connector of the flexible pipe and are found in a submarine environment in deep waters.

As illustrated in FIG. 2, the location of the relief valve may vary according to the pipe manufacturer, usually in a radial position (convex region) or axial position (flat region). In the state of the art, there are specific components to be used depending on variations in size of the relief valve, connector surface condition and positive or negative pressure variation when performing the inspection.

For the inspection of the annulus of the pipes, through the relief valve, a chamber is generally created and connected to a system that applies a pressure variation to the relief valve. However, the sealing of this chamber generally occurs with the insertion of the tool in the relief valve housing, requiring an accurate alignment of the tool. Such a difficulty is further exacerbated since the inspection operation is carried out in a submarine environment in deep waters, this being a tele-operated operation, carried out by ROV.

Therefore, a tool is needed that allows flexibility in the inspection of the annulus of flexible pipes through relief valves and that meets the various variations in the positioning of relief valves, varied surface conditions of connectors of flexible pipes and/or positive or negative pressure variations when inspecting flexible pipes from different manufacturers.

### STATE OF THE ART

In the state of the art, there are tools for inspecting the annulus of flexible pipes through relief valves, some of which are applicable to operations carried out by ROV in a submarine environment in deep waters.

One of these tools is disclosed in document BR 102019025812-8. Such a document describes, in general, a system and method for reducing pressure and draining the annulus of flexible pipes by means of ROV.

Relevantly to the matter of the present application, the document describes that the system consists of a cylinder and piston assembly that is installed in the recess of the relief valve of the pipe connector and providing sealing to the cylinder against the wall of the valve recess.

Further, it is disclosed that the sealing of the device on the wall of the recess of the relief valve, providing tightness to the outer environment, can be done by energizing polymeric rings or metallic rings against the wall and the bottom of the recess, or by opening of threads in the wall of the recess.

Finally, such a document discloses that, as soon as the device is installed and sealed from the outer environment, the reduction of the pressure of the annulus is done by driving a shut-off valve and, after the execution of the operation of reducing the annulus pressure, the shut-off valve is closed, the sealing system is de-energized, and finally the device is removed from the relief valve recess of the pipe connector.

One of the main disadvantages of using a seal as disclosed in document BR 102019025812-8 is that, due to the requirement to insert the seal into a metallic housing, any slight misalignment can end up damaging or cutting the seal, preventing inspection and resulting in delays and additional operating costs.

On the other hand, the innovative solution of the present invention does not require the insertion of a tool in the recess of the relief valve of the connector of flexible pipes, since it uses a compliant feature of passive adaptation, adapting to the surface of the connector to the surrounds the relief valve.

With the proposed solution, therefore, a high degree of flexibility is obtained in the positioning of a tool for inspection and, further, the possibility of complying with different manufacturers of flexible pipes through the use of the compliant feature of passive adaptation, capable of absorbing variations of the contact condition, flat or convex, of a connector.

Such a flexibility makes it possible to use a unique sealing system, during the inspection of flexible pipes in deep water, in addition to supporting a variation of positive pressure (the inner pressure is greater than outer pressure) and negative (the inner pressure is lower than outer pressure).

Although the use of the present invention has been indicated for the inspection of the annulus of flexible pipes through relief valves, it will be appreciated by a technician skilled on the subject that this invention would not be limited to this exemplary case. Indeed, the present invention is also promising for other types of underwater inspections in deep waters.

Other features and advantages of the present invention will clearly emerge from the detailed description below and with reference to the accompanying drawings, these being provided only as a preferred and non-limiting embodiment.

### BRIEF DESCRIPTION OF THE INVENTION

The present invention pertains the technical field of subsea equipment technologies dedicated to the inspection of pipes and risers and describes, according to preferred embodiments of the invention, an inspection tool and a system that comprise a compliant feature of passive adaptation for the inspection of the annular region of flexible pipes.

The inspection tool comprises a mechanical structure with a chamber and a two-way sealing assembly comprising an inner seal and an outer seal that create a tight connection for carrying out inspection operations. Furthermore, a system for the inspection comprising at least the inspection tool, an anchoring mechanism, an approximation mechanism and an ROV is foreseen.

### BRIEF DESCRIPTION OF FIGURES

In order to complement the present description and obtain a better understanding of the features of the present invention, a set of figures is presented, where in an exemplified, non-limitative manner, preferred embodiments of the same are represented.

FIG. 1 illustrates an exemplary cross section of a flexible pipe and its connector, disclosing the position of relief valves and other usual components.

FIG. 2 illustrates an exemplary cross section of connectors of flexible pipes, illustrating radial and axial positions of positioning relief valves.

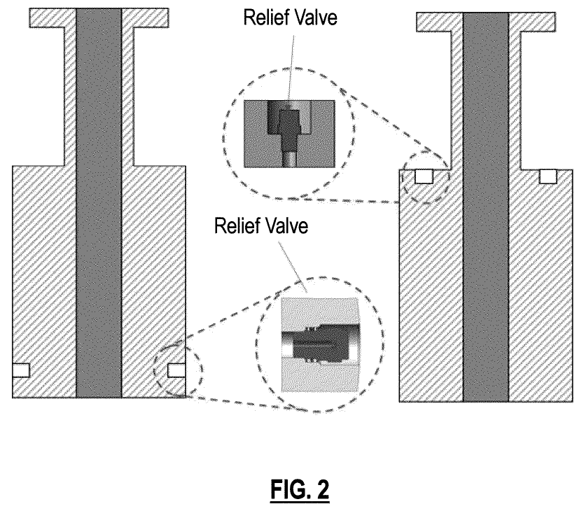

FIG. 3 illustrates a perspective view of an inspection tool according to a preferred embodiment of the present invention.

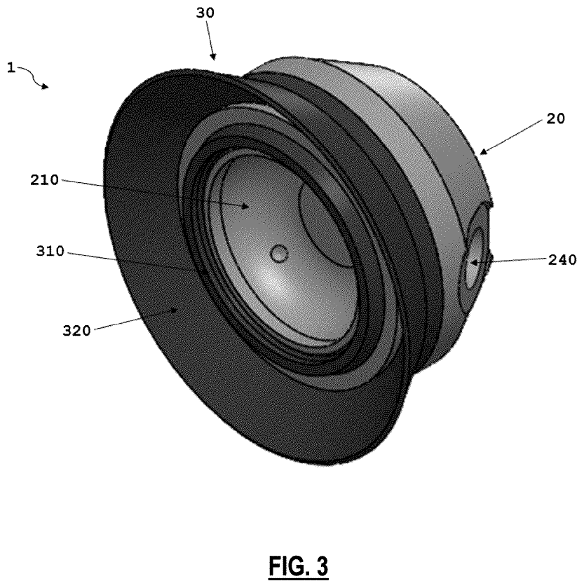

FIG. 4 illustrates a top view of an inspection tool according to a preferred embodiment of the present invention.

FIG. 5 illustrates a bottom view of an inspection tool according to a preferred embodiment of the present invention.

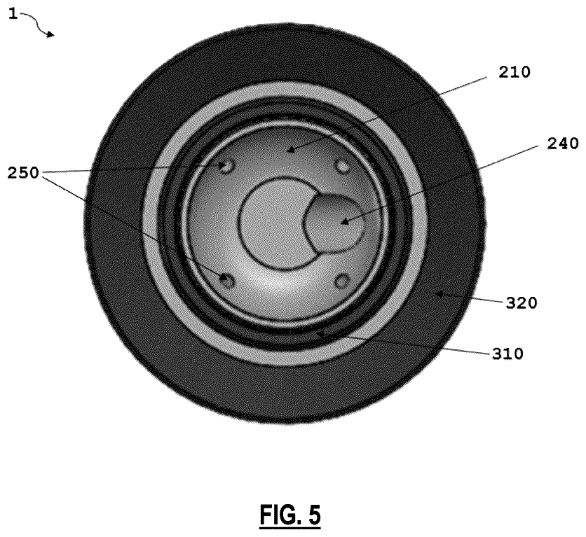

FIG. 6 illustrates a first cross-sectional view of an inspection tool according to a preferred embodiment of the present invention.

FIG. 7 illustrates a second cross-sectional view of an inspection tool according to a preferred embodiment of the present invention.

FIG. 8 illustrates a third cross-sectional view of an inspection tool according to a preferred embodiment of the present invention.

FIG. 9 illustrates a simplification of possible pressure conditions to which the present invention could be subjected.

FIG. 10 illustrates a non-limiting example of the driving of an anchoring mechanism and a radial approximation mechanism for positioning and approximating the inspection tool to a relief valve of a connector.

FIG. 11 illustrates a non-limiting example of the driving of an anchoring mechanism and an axial approximation mechanism for positioning and approximating the inspection tool to a relief valve of a connector.

FIG. 12 illustrates a graph of the evolution of an annular tightness test (dry).

FIG. 13 illustrates a graph of the evolution of an annular tightness test (flooded).

### DETAILED DESCRIPTION OF THE INVENTION

The present invention was designed to enable a tight connection between an inspection tool and a surface of a subsea equipment, preferably a tight connection between pressure relief valves installed in connectors of flexible pipes. This connection allows the hydraulic communication between the tool and the annulus of the pipe, so that, preferably, the inner pressure of the annulus can be evaluated.

The present invention can further be used to transfer a sample of the fluid contained in the annulus of the pipe to a collection cylinder, for further evaluation of the composition thereof. This is possible due to the tightness provided by the present invention, not allowing the entry of sea water to contaminate the sample.

In general, the present invention allows the tight subsea connection between two chambers, through the contact force between the present invention and the chamber to be connected. Therefore, any scenario where such a communication is required, the present invention is amenable to be considered.

An inspection tool 1, according to a preferred embodiment of the present invention, is described in detail, based on the attached figures.

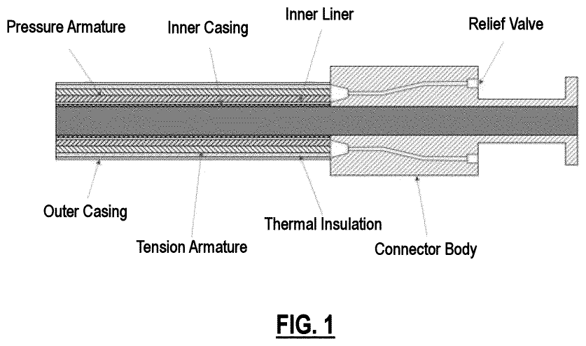

As illustrated in FIG. 1, the inspection tool 1 essentially comprises a mechanical structure 20 and a sealing assembly 30. The seal consists of an inner seal 310 and an outer seal 320. The inner seal 310 and the outer seal 320 are clamped in respective housings present in the mechanical structure 20.

The mechanical structure 20 and the sealing assembly 30 have a generally circular shape. This shape is preferred, as it facilitates the formation of a tight seal of the tool on the surface of the connector of the flexible pipe for inspection operations. However, it will be appreciated by a technician skilled on the subject that, without departing from the scope of the present invention, the structure 20 and the sealing assembly 30 could optionally have any one of an oval, oblong, rectangular, square or other shape depending on the application.

In general, not limiting, the inspection tool 1 of the present invention was designed to work with a range of diameters, preferably between 450 mm and 650 mm, these being the typical dimensions of connectors of flexible pipes.

The inspection tool 1 is further designed to be positioned on a relief valve of a connector of flexible pipes. Preferably, the sealing assembly 30 substantially surrounds the relief valve.

In this sense, inspection tool 1 is sized according to the dimensions of a relief valve housing to be inspected; preferably, the inspection tool 1 is sized with a clearance, that is, with dimensions greater than those dimensions of a relief valve housing.

Therefore, an advantage of the present invention is that the inspection tool 1 is not inserted into a relief valve housing.

Further, another advantage of the present invention is that an accurate alignment of the positioning of the inspection tool 1 is not required, since the connection shape and the compliance of the sealing assembly allow overcoming positioning errors of the inspection tool 1, while ensuring a tight connection.

Therefore, due to at least the above advantages, the present invention allows greater agility and flexibility in carrying out an inspection operation of relief valves of connectors of flexible pipes.

The mechanical structure 20 is manufactured from metallic materials with high corrosion resistance, such as stainless steels and nickel alloys. Preferably, the mechanical structure 20 is fabricated from stainless steel, more preferably from 316 stainless steel.

The inner seal 310 and the outer seal 320 of the sealing assembly 30 are made from polymeric materials. Preferably, the inner seal 310 and the outer seal 320 are manufactured from polyether-based polyurethane. The hardness of the polyether-based polyurethane is preferably from 55 to 95 Shore A, more preferably, the hardness is approximately 90 Shore A.

The inner seal 310 has a shape corresponding to the shape of the structure 20. Preferably, the inner seal 310 has a generally circular shape. Further, the inner seal 310 preferably has a generally trapezoidal cross-sectional shape, which corresponds to a shape of a housing 220 for the inner seal 310 on the underside of the mechanical structure 20. The generally trapezoidal cross-sectional shape of the inner seal 310 has the function of supporting most of the contact force of inspection tool 1, seeking to maintain uniform pressure throughout the contact area.

The outer seal 320 has a shape corresponding to the shape of the structure 20. Preferably, the outer seal 320 has a generally circular shape. Further, the outer seal 320 preferably has a generally triangular cross-sectional shape, wherein there is a radially outwardly gradual reduction in cross-section. The general shape of the outer seal 320 is similar to that of a suction cup, with a compliant geometry and that presents flexibility to accommodate and copy a surface onto which the inspection tool is pressed.

Furthermore, the outer seal 320 comprises, in a thicker upper portion of its cross section, a feature for clamping in a side coupling 230 of the mechanical structure 20. Said feature for clamping the outer seal 320 has a complementary shape to a shape of the side coupling 230 of the mechanical structure 20.

The side coupling 230 surrounds the periphery of the mechanical structure 20 and comprises a feature of lock channel 231 and a feature of shoulder 232. The feature of lock channel 231 and of shoulder 232 have the function of housing the outer seal 320 when it is clamped to the side coupling 230.

The mechanical structure 20 has the following main functions: accommodating/supporting the inner seal 310 and outer seal 320, creating a tight chamber, enabling fluid communication between ports and/or channels with the surface/chamber to be inspected and enabling the assembly and driving of the inspection tool 1.

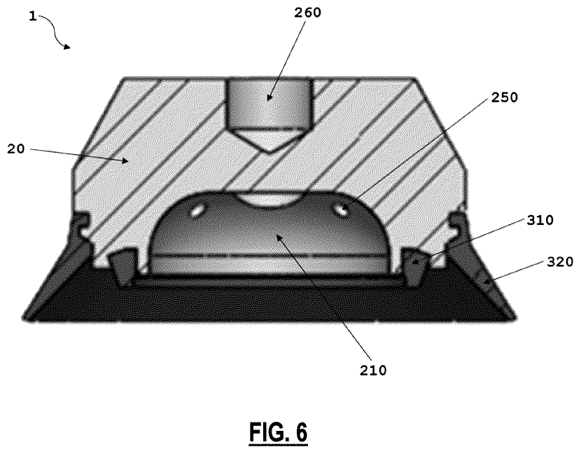

As disclosed in FIGS. 1 and 6 to 8, the mechanical structure 20, on its underside, comprises a chamber 210. The chamber 210 is generally centered on the underside of the mechanical structure 20 and has a generally semi-spherical volume. Further, a diameter of the chamber 210 must be suitable for coupling the inspection tool 1 on a surface or chamber to be inspected of a subsea equipment.

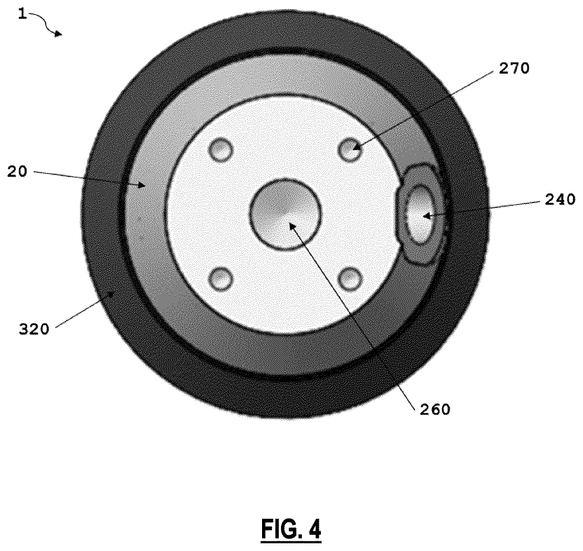

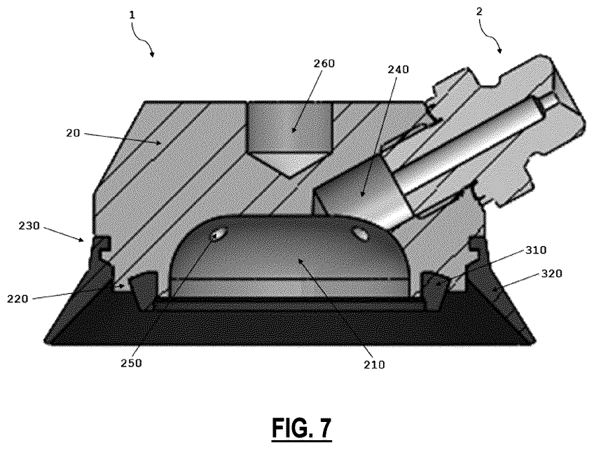

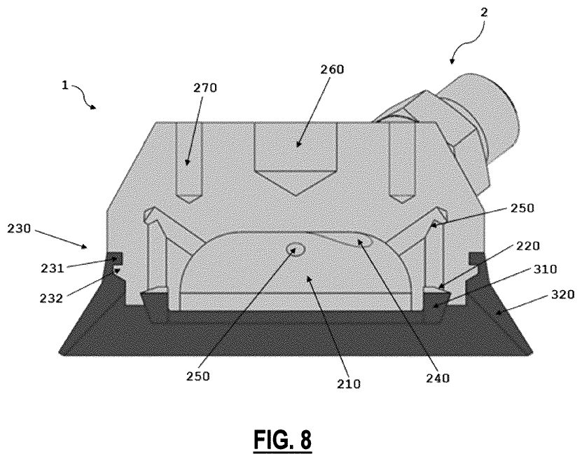

As shown in FIGS. 7 and 8, the chamber 210 fluidly communicates with a communication port 240 and at least one pressurization channel 250. As further disclosed in FIG. 4, the communication port 240 is preferably arranged in a generally side position between the sealing assembly 30 and a stem housing 260.

The communication port 240 enables fluid communication between the tool chamber and a plurality of types of valves. In an exemplary, non-limiting way, FIGS. 7 and 8 disclose a configuration wherein a valve 2 is coupled to the communication port 240 and in fluid communication therewith.

It will be appreciated that the communication port 240, with or without the coupling of a valve 2, allows a fluid connection with an ROV, probe, vessel or any other subsea or surface equipment for carrying out tests, inspections and/or sampling. Preferably, the communication port 240 allows the fluid communication between the annulus of a flexible pipe, the inspection tool 10 and an ROV, so that the inner pressure of the annulus can be evaluated/inspected by a teleoperated operation.

As illustrated in FIG. 8, the at least one pressurization channel 250 fluidly communicates with a housing 220 for clamping the inner seal 310. Preferably, the housing 220 has a generally trapezoidal cross-sectional shape.

The at least one pressurization channel 250 assists in the contact pressure of the inner seal 310. In this sense, when a positive pressure is applied to the volume of the chamber 210 of the inspection tool 1, this pressure acts, through at least one pressurization channel 250, on a backside of the inner seal 310 and helps keep the inner seal 310 in contact with a surface.

Preferably, the chamber 210 fluidly communicates with at least 4 pressurization channels 250.

The mechanical structure 20, on its upper side, further comprises means for connection and means for housing. The means for housing is a stem housing 260. Preferably, the stem housing 260 is recessed from the upper side surface of the mechanical structure 20 and generally centered therewith. The stem housing 260 has the function of enabling pressuring of the inspection tool 1 to create a tight connection between the inspection tool 1 and pressure relief valves installed in the connectors of flexible pipes.

The inspection tool 1 is pressed against the surface of the connector of the flexible pipe, through the stem housing 260, with a force between 5 and 15 kN, preferably with a force of approximately 7.5 kN.

The means for connection are preferably at least four mounting holes 270, arranged spaced around the mounting holes 270, as shown in FIGS. 4, 6 to 8. The at least four mounting holes 270 have the function to make it possible to couple an ROV. Preferably, the coupling is a threaded coupling.

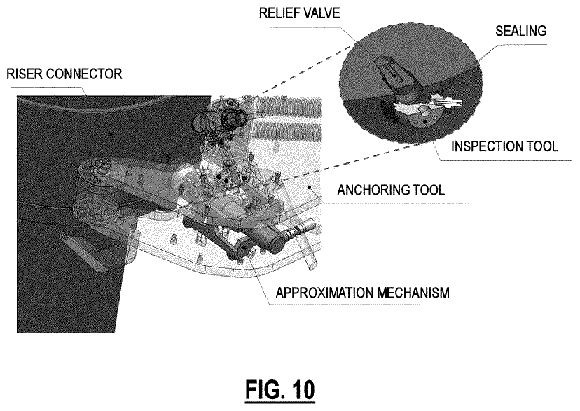

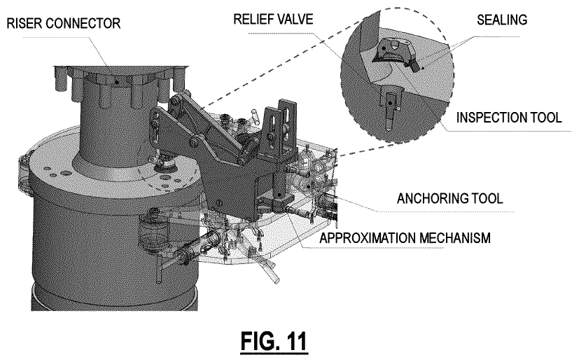

The ROV, as illustrated, for example, in FIGS. 10 and 11, is optionally equipped with equipment for handling and positioning the inspection tool 1. Among the preferred equipment, but not limited to these, the ROV comprises an anchoring mechanism, an approximation mechanism and one or more cameras, distance and/or positioning sensors.

The distance and/or positioning sensors can be any of inductive, optical, ultrasonic, laser, proximity sensors, position encoders, GPS, among others.

The anchoring mechanism can be of claw type, with or without pulleys, commonly used for anchoring ROVs to subsea equipment, pipelines or connectors.

The approximation mechanism can have different shapes and/or displacement modes; preferably, the approximation mechanism is a mechanism adapted for the axial (FIG. 11) and/or radial (FIG. 10) positioning of the inspection tool 1 on the relief valve of the connector of the flexible pipe.

The combination of movements provided by the optional approximation and anchoring mechanisms assist in the positioning and approximation of the inspection tool 1 in relation to the relief valve of the connector of the flexible pipe for carrying out inspection procedures.

The sealing assembly 30, consisting of inner seal 310 and outer seal 320, can be described as a two-way seal. The sealing assembly 30 can withstand both a positive pressure difference and a negative pressure difference between the pressure in the chamber 210 of the inspection tool 1 and ambient pressure (subsea deep water environment).

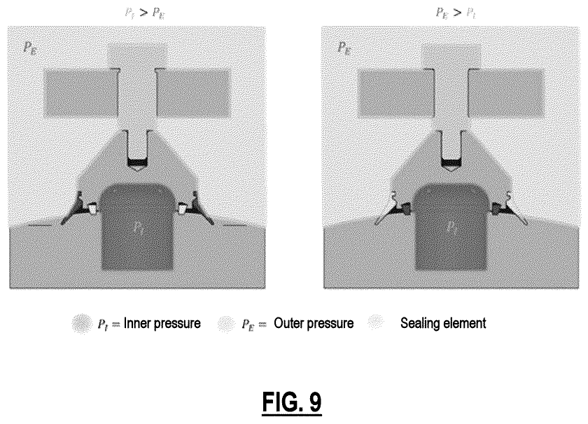

FIG. 9 illustrates a simplification of possible pressure conditions to which the present invention could be subjected. The illustration on the left presents a pressure condition wherein the inner pressure is greater than the outer pressure. The illustration on the right presents a pressure condition wherein the outer pressure is greater than the inner pressure. In addition, it is indicated which sealing element would be under greater demand in a given condition.

In the condition that the inner pressure is greater than the outer pressure, the sealing element under greater stress is preferably the inner seal 310. In turn, in the condition that the outer pressure is greater than the inner pressure, the sealing element under greater stress is preferably the outer seal 320. The demand is a sealing/tightness demand.

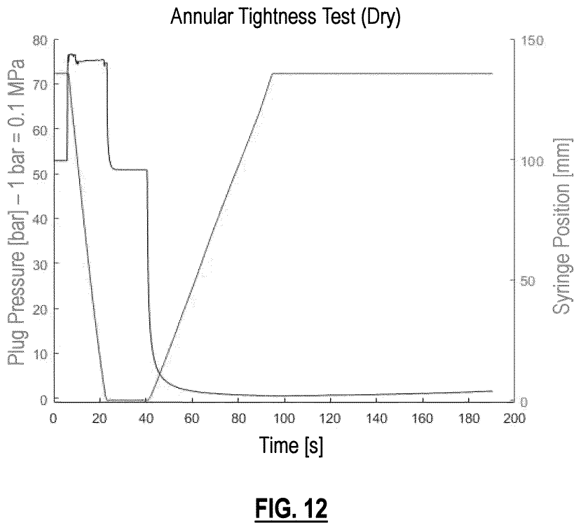

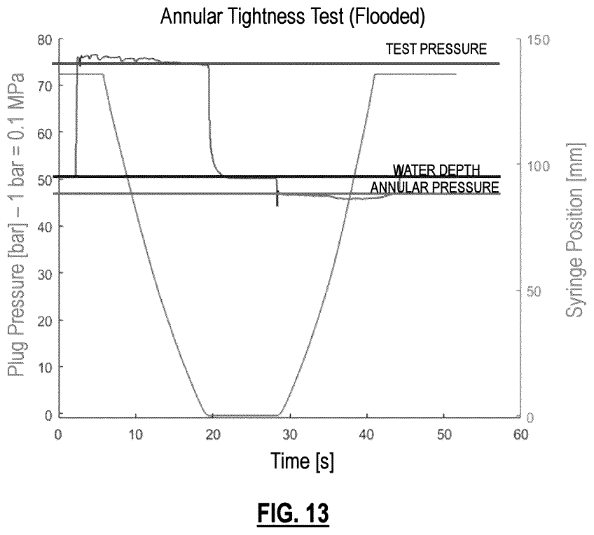

In order to allow a clear and precise understanding of how an inspection is performed by the present invention, an exemplary, non-limiting description of the graphs in FIGS. 12 and 13 will be provided below.

FIG. 12 illustrates a graph of the evolution of a dry annular tightness test. In said graph, a characteristic curve of inspection of a dry annulus can be seen, where the blue curve is the behavior of the pressure inside the tool chamber and the red curve the displacement of the syringe plunger. The pressure variation generally follows the following steps: 1—Pressurization of the tool chamber; 2—Stabilization with environment; 3—Depressurization of the tool chamber; 4—Stabilization with environment; 5—Tool chamber pressurization; 6—Stabilization with environment.

FIG. 13 illustrates a graph of the evolution of a flooded annular tightness test. Further, said graph highlights a condition of inner pressure greater than the outer pressure and a condition of outer pressure greater than the inner pressure.

In this sense, during the inspection process, it is necessary to test the correct positioning of the inspection tool 1 as well as the effectiveness of the seal; for this, a positive pressure difference is applied, making the inner pressure of the inspection tool 1 greater than the ambient pressure. The red line highlights such a test pressure.

On the other hand, for the connector relief valve to open, it is necessary to apply a negative pressure difference, making the inner pressure of the inspection tool 1 lower than the ambient pressure. The green line highlights such an annular pressure.

A system for inspecting an annulus through the relief valve of a connector of a flexible pipe, according to a preferred embodiment of the present invention, is described below.

The inspection system comprises, as illustrated, but not limited to FIGS. 10 and 11, at least: an inspection tool 1, an anchoring mechanism, an approximation mechanism and a ROV.

Preferably, the anchoring mechanism and the approximation mechanism are, respectively, handled and hydraulically driven by means of the ROV.

The inspection tool 1 is mounted on the approximation mechanism that, in turn, is mounted on the anchoring mechanism. The ROV then handles the assembled assembly to subsea equipment to be inspected, such as, for example, a connector of flexible pipe comprising a relief valve.

Preferably, the approximation mechanism is one of an axial approximation mechanism or a radial approximation mechanism.

The ROV positions the assembly in proximity to a connector of the flexible pipe and closes the anchoring mechanism in order to support the assembly in the required position. Preferably, the anchoring mechanism comprises a claw and pulleys.

Next, the ROV drives the anchoring mechanism and approximation mechanism in order to position, generally, the inspection tool 1 on the inspection site. Preferably, the positioning of the inspection tool 1 on the inspection site is aided by one or more cameras and distance and/or positioning sensors.

The ROV then drives the approximation mechanism to an advanced position, from a retreated position, in order to move the inspection tool 1 and press the same against the surface of the connector, over a relief valve, to create a tight connection.

After carrying out the necessary inspection procedures, the ROV then drives the approximation mechanism to withdraw the same and the inspection tool 1 from the connector surface, and then drives the opening of the anchoring mechanism to unanchor the subsea pipe connector assembly.

In this way, those skilled in the art will value the knowledge presented herein and will be able to reproduce the invention described in the presented embodiments and in other variants, encompassed by the scope of the attached claims.

1. An inspection tool comprising:
a mechanical structure comprising:
a chamber;
a housing positioned adjacent the chamber;
a fluid communication port in fluid communication with the chamber;
at least one pressurization channel in fluid communication with the chamber; and
a side coupling disposed on an outer periphery of the mechanical structure; and
a sealing assembly comprising:
an inner seal clamped in the housing of the mechanical structure;
an outer seal clamped in the side coupling of the mechanical structure.

2. The inspection tool of claim 1, further comprising a valve coupled to the fluid communication port, the valve fluid communication with the chamber.

3. The inspection tool of claim 1, wherein the chamber comprises a hemi-spherical volume and is centrally arranged on an underside of the mechanical structure.

4. The inspection tool of claim 1, wherein the mechanical structure and the sealing assembly are circular in shape.

5. The inspection tool of claim 1, wherein the sealing assembly comprises polyether-based polyurethane.

6. The inspection tool of claim 1, wherein the inner seal has a trapezoidal cross-sectional shape, which corresponds to a cross-sectional shape of the housing.

7. The inspection tool of claim 1, wherein the outer seal has a triangular cross-sectional shape, which radially tapers in an outward direction.

8. The inspection tool of claim 7, wherein the outer seal further comprises, in a thick upper portion clamped to the side coupling of the mechanical structure.

9. The inspection tool of claim 1, wherein the side coupling comprises a lock channel and a shoulder.

10. (canceled)

11. The inspection tool of claim 1, wherein the at least one pressurization channel fluidly communicates with the housing.

12. The inspection tool of claim 1, wherein the mechanical structure further comprises:
a stem housing (260) positioned centrally on an upper surface; and
at least four mounting holes arranged circumferentially around the stem housing.

13. The inspection tool of claim 12, wherein the stem housing is recessed from the surface of the upper side of the mechanical structure and centralized in relation to the same.

14. The inspection tool of claim 11, wherein the at least four mounting holes are arranged concentrically around the stem housing.

15. A system for inspection comprising:
an inspection assembly comprising:
an anchoring mechanism;
an approximation mechanism mounted on the anchoring mechanism; and
an inspection tool mounted on the approximation mechanism;
one or more cameras; and
an remote operated vehicle (ROV) for positioning the assembly in proximity to a relief valve of a flexible pipe to be inspected, wherein the anchoring mechanism and the approximation mechanism are hydraulically driven by the ROV.

16. The system of claim 15, wherein the approximation mechanism is configured to position the inspection tool on one of an axial or radial position on the connector of the flexible pipe.

17. The system of claim 15, wherein the anchoring mechanism comprises a claw and one or more pulleys.

18. The system of claim 15, wherein the system further comprises one or more of a distance sensor and a positioning sensor.

19. The inspection tool of claim 1, wherein the mechanical structure comprises stainless steel.

20. The inspection tool of claim 12, wherein the communication port is positioned on a side of the mechanical structure between the sealing assembly and the stem housing.

21. A method of inspecting a subsea flexible pipe comprising:
positioning, via a remotely operated vehicle (ROV), an inspection assembly in proximity to a connector of a flexible pipe;
anchoring the inspection assembly to the pipe via an anchoring mechanism;
advancing an inspection tool via an approximation mechanism toward a relief valve on the connector;
pressing the inspection tool against the surface of the connector and over the relief valve, to create a tight connection; and
measuring the pressure within the flexible pipe.
